(19) United States
(12) Patent Application Publication
(10) Pub. No.: US 2015/0039452 A1
(43) Pub. Date: Feb. 5, 2015

(54) Consolidated Retailer-Operated Electronic Payment System

(71) Applicant: Wal-Mart Stores, Inc., Bentonville, AR (US)

(72) Inventors: Suyog Barve, Ujjain (IN); Pradeep Kumar Gupta, Bangalore (IN); Gautham Varada, Bangalore (IN); Chris Venable, Bentonville, AR (US); Hemalatha Balakrishna, Bangalore (IN)

(73) Assignee: Wal-Mart Stores, Inc., Bentonville, AR (US)

(21) Appl. No.: 13/953,849

(22) Filed: Jul. 30, 2013

(51) Int. Cl. G06Q 20/40; G06Q 20/20

(52) U.S. Cl. CPC G06Q 20/40; G06Q 20/20
USPC 705/16; 705/44

(57) ABSTRACT

A consolidated electronic payment system operated by a retailer exclusively for its customers is disclosed. Otherwise independent and limited authentication and payment resources are consolidated within the unified system, facilitating broader access at retail checkout to several payment instruments. System functions are executed jointly by a customer-facing checkout facility and backend network resources comprising an authentication agent and a payment processor. Individual customers registered within the system are assigned a primary customer account, which is recorded within the network's data storage facility. Associated with these accounts are all available payment instruments and certain existing authentication accounts. For retail transactions, personal identification information and payment instructions submitted by the customer are transmitted to the network from checkout, with pertinent authentication and payment signals generated and transmitted back in response thereto.

### FIELD

The present invention relates in general to electronic payment systems, and in particular, to an electronic payment system operated by and for a retailer with consolidated authentication and payment resources.

### BACKGROUND

Electronic payment systems—well known and used pervasively for a variety of commercial and financial transactions—has lately become an area of vigorous technological development.

Fueled in part by the growth and expansion of the internet and its recipient ecommerce industries, there have now been developed numerous electronic payments systems and platforms offering several and various means for exchanging, registering, crediting, debiting, storing, and transferring money, monetary equivalents, and other exchangeable financial interests between and among parties.

In addition to the continuing development of such electronic payment systems, there has also lately been interest in the development (e.g., for facilitating ecommerce transactions) of so-called “digital wallets”, which are essentially secure data files that record monetary data and values sourced from multiple financial providers. Digital wallet services are offered, for example, by Google, Inc., “PayPal” (i.e., eBay, Inc.), and Amazon.com, Inc. Despite substantial promotional efforts, these technologies are still in their infancy, with limited application and adoption outside a comparatively narrow set of ecommerce retailers.

While retailers continue to implement the latest electronic payment systems, it has generally been understood that apart from being a threshold requirement for conducting business, implementation affords little intrinsic competitive advantage there being only scant, if any, opportunity to differentiate meaningfully the retailer's payment services from those of its competitors. All tend to subscribe to the same payment systems.

Regardless, in considering recently the current state of electronic payment systems (including the new digital wallet technologies) for the retail industry, it was observed that consolidation within a unitary framework of these otherwise independently-operated payment systems, including their varying authentication and payment mechanisms, specifically at the retail point-of-sale, can provide a compelling customer shopping experience and engender substantial commercial differentiation, goodwill, and customer loyalty.

Incorporated within such framework, payment instruments not normally used for retail shopping could be tapped by the customer to consummate purchases, providing both greater flexibility and a substantial convenience. In one particular example, a digital wallet having limited to no utility outside the internet could be consolidated into the retailer's system, and thereby accessed and used by the customer to purchase merchandise at one of the retailer's shopping facilities.

Moreover, operated and thereby customizable by the retailer, authentication can be engineered to use a standardized retailer-defined protocol that, for example, eliminates the need for the customer to carry an identity card or other security token (e.g., by providing security through other safeguards within the retailer's control). A customer with neither cards nor cash on hand can thus still shop at a retailer-operated shopping facility and purchase his merchandise, for example, by accessing his consolidated payments instruments through a predefined password or knowledge based authentication protocol.

While the advantages are compelling, there are no known retailer-operated electronic payment systems or programs that provide such functionality.

### SUMMARY

In response to the above need, an electronic payment system is disclosed that is operated by a retailer exclusively for its customers and is engineered specifically to promote broad and comparatively easy access to several payment instruments at retail checkout.

Otherwise independent authentication and payment resources—owned by, associated with, or linked to a customer—are consolidated within a unified retailer-operated electronic payment system. In respect of security, the comparatively easier access to payment instruments under the consolidated system is balanced (or otherwise checked) by the system's jurisdictional exclusivity. Merchandise is purchased from the retailer only at participating retailer-operated checkout locations.

In general, the functionality of the electronic payment system is executed at a customer facing front-end by a retailer-operated checkout station (or the like), and at a backend, by a retailer-operated computer network, the network comprising at least an “authentication agent” and a “payment processor”.

Individual customers registered within the system are assigned a primary customer account, recorded within the network's data storage facility. Associated with these accounts are any and all available payment instruments and certain existing authentication accounts.

In preferred embodiments, a web server is also deployed within the retailer's network to provides a customer interface (i.e., at an internet site) for creating, accessing, and editing the customer's primary customer account (e.g., adding and removing payment instruments and existing authentication accounts).

In the course of conducting a retail transaction, personal identification information and payment instructions submitted by the customer are transmitted to the network from checkout, with pertinent authentication and payment signals being generated and transmitted back in response thereto.

In light of the above, it is a principal objective of the invention to provide an electronic payment system operated by and for a retailer with consolidated authentication and payment resources.

It is another object of the invention to provide a retailer-operated electronic payment systems that enables customer access at checkout to one or more payment instruments.

It is another object of the invention to provide a retailer-operated electronic payment system that enables customer access at checkout to one or more payment instruments using a single cardless (or otherwise tokenless) login.

It is another objective of the invention to provide an electronic payment system providing customer access at checkout to consolidated payment instruments, and wherein the backend assets of the system comprise, within the jurisdictional control of the retailer, data storage facilities, an authentication agent, a payment processor, and a web server.

It is another object of the invention to provide an electronic payment system with consolidated authentication and payment resources, wherein the consolidated authentication resources comprises a definable set of existing customer accounts, and preferably, wherein the existing accounts are legacy accounts held by the customer with the retailer and/or it's current and prior affiliates and subsidiaries.

For a further understanding of the nature and objects of the invention, reference should be had to the following description taken in conjunction with the accompanying drawings.

### BRIEF DESCRIPTION OF THE DRAWINGS

FIG. 1 illustrates schematically a consolidated electronic payment system 100 engineered in accordance with a representative embodiment of the invention.

FIG. 2 provides a cross-functional flow chart showing certain steps of a method performed within a consolidated electronic payment system pursuant to a representative implementation of the invention.

FIGS. 3A to 3H illustrate certain features and functions provided by an internet site 300 used for a consolidated electronic payment system, as per a representative embodiment of the invention.

FIGS. 4A and 4B illustrate schematically certain features and functions of a customer payment terminal used at checkout in a consolidated electronic payment system, as per a representative embodiment of the invention.

### DETAILED DESCRIPTION

The present invention provides a retailer-operated electronic payment system with consolidated authentication and payment functionalities.

In respect of authentication, the electronic payment system is arranged to permit the consolidation and use of existing internal or external customer accounts within a unified customer authentication framework, the login therefor being defined by customer selection of one of the existing accounts, preferably one following a cardless authentication protocol.

In respect of payment functionality, the electronic payment system is arranged to permit consolidation, preauthorization, and use of otherwise autonomous payment instruments (e.g., credit cards and bank accounts), and thereby enable a customer authenticated through the system to access anyone or more of such payment instruments as the customer so chooses at the time of purchase (i.e., at a retailer-operated shopping facility).

The retailer-operated payment system relies upon coordination of two primary entities: (a) a retailer-operated operated computer network and (b) a checkout system established at a retailer-operated shopping facility. The specific assets, features, and functions of each varies among the principal embodiments of the invention as set forth herein below. Nonetheless, in all such embodiments, the back end functions occurs at the central computer network, whereas front end access and input of pertinent instruction and information by the customer occurs at checkout.

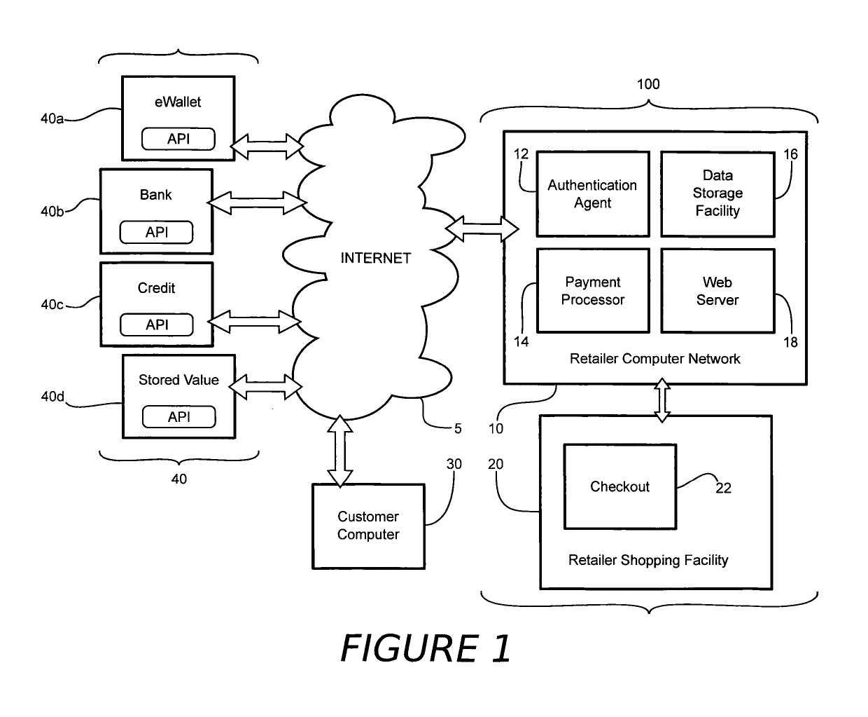

A basic framework for the invention is illustrated in FIG. 1, the retailer-operated payment system 100 of the invention being shown therein to comprise a retailer-operated computer network 10 and checkout means 22 located at a retailer-operated shopping facility 20.

The retailer-operated computer network 10 includes a data storage facility 18, an authentication agent 12, and a payment processor 14. Details of each component are provided further herein below. In short, however, the data storage facility is configured for storage of a primary customer account assigned by said retailer to the customer, the primary customer account having associated therewith a customer-defined group of payment instruments and one or more existing customer accounts, each existing customer account having a unique account identifier. The authentication agent 12 is configured for transmitting a customer authentication signal as a function of receiving and authenticating the account identifier of at least one of said existing customer accounts. And, the payment processor 14 is configured for processing a payment instruction and subsequently transmitting a payment signal composed as a function of said processing, the payment instruction including a selection of at least one of said group of payment instruments.

In respect of checkout means 22, it is provided within a retailer-operated shopping facility 20, and so disposed therein to be in communication with the retailer's computer network 10, providing a customer interface for authentication and electronic payment. It receives authentication information from a customer, transmits it to the network's authentication agent 12, and receives an authentication signal in response. Similarly, upon authentication, checkout means 22 requests and receives payment instructions from the customer, transmits them to the network's payment processor 14, and receives in response thereto a payment signal that is used to consummate or otherwise effect a retail transaction.

Whereas the principal embodiment of the invention is distinguished primarily in respect of its jointly consolidated authentication and payment functions, in the other principal embodiments of the invention, emphasis is skewed toward the exclusivity of operation and use of the system. In these embodiments, all principal assets and resources of the system are operated by or within the control of the retailer. Unlike other commoditized electronic payment systems and services offered by third party financial entities, the retailer's system is essentially operated as a “closed system”, i.e., the services provided thereunder by the retailer are for its customers only. To provide even deeper customer input and controls within such a customer-focused framework, as shown in FIG. 1, a web server 18 is included to provide a customer interface (e.g., such as in a website) for creating, accessing, and editing the customer's primary customer account.

While the invention is embodied principally as a system, framework, or program, its operation involves the performance of a closely related methodology, that is in itself innovative.

In particular, the method involves the steps of (a) providing a retailer-operated computer network hosting a customer account have associated therewith a customer-defined group of payment instruments, and capable of authenticating a customer as a function of submitted personal information and subsequently authorizing payment from at least one of the group of payment instruments as per a customer instruction; (b) providing a checkout station located at the retailer-operated store that includes a customer payment terminal in communication with the network; (c) authenticating the customer at checkout by requesting said customer to input personal identification information at the customer payment terminal and transmitting the personal identification information to the network; and (d) authorizing payment by requesting the customer to input an appropriate customer instruction at the customer payment terminal and transmitting it to the network, the payment instruction including a selection of at least one of the payment instruments.

The types of participating retailer-operated shopping facilities in which this system can be implemented can be diverse, encompassing both physical retail facilities (such as department stores, grocery stores, and other so-called “brick-and-mortar”type operations) and virtual electronic storefronts (such as an ecommerce retail website). Accordingly, as used herein, the term “retailer-operated shopping facility” is defined as any facility where merchandise is commercially offered for sale to customers by the retailer.

Although global retailers will likely wish to implement the invention in more than one store, it will be appreciated that the scope of the invention is not limited to multi-store implementations. Advantages of the invention can be realized even within a single shopping facility—or even a single checkout lane.

For global retailers that do operate several shopping facilities, including ecommerce websites and like electronic storefronts, it will be further appreciated that the invention does not require that each of such retailer-operated shopping facilities implement the inventive payment system. The decision to implement the invention in certain select facilities will likely be a business decision, weighing and influenced by the usual and well known commercial and regulatory factors. Nonetheless, even if not implemented in all facilities, the invention inherently promotes broad customer loyalty and commercial goodwill, which ultimately impinges favorably upon even non-participating facilities.

In embodiments of the invention wherein an ecommerce website serves as the “retailer-operated shopping facility”, concurrence of both consolidated authentication and consolidated payment systems is preferred. This front and backend co-consolidation—particularly in its enablement of selectable authentication modalities—adds meaningfully to the immediacy and convenience of the system, both attributes being key hallmarks of the online shopping experience. Moreover, for well established retailers with a long history of traditional retail operations, wherein a plethora of existing and active customer accounts may have proliferated over years of growth, unification of such accounts through the inventive system can facilitate and/or accelerate adoption of more contemporary ecommerce based retailing, particularly among the retailer's long standing loyal customer base.

In respect of its technical details and configuration, the “retailer-operated computer network” 10 can be engineered in accordance with well-known network architectures and topologies and—in addition to it unique components—can comprise a plurality of interconnected computers and terminals, servers, hubs, routers, switches, network security devices, network management devices, wireless nodes and access points, load balancers, and related software.

The physical topology of the retailer's core network can be quite broad and extensive, with its components widely distributed over different locations, if not different geographies. With an eye towards unification, however, the logical topology of its core functions is nonetheless preferably “centralized” to promote good data flow, signal strength, ease of management, and accessibility. The components of network 100 pertinent to the invention are also preferably disposed centrally therein to facilitate contemporaneous access and utilization by several remote stores operated by the retailer at the loads and bandwidths expected for uninterrupted business operations, thereby promoting further system consolidation and uniformity.

With the system and its components engineered into the retailer's computer network, the invention can be commercially presented and marketed to customers as a convenient and flexible alternative electronic payment mechanism used at checkout instead of, but not replacing, traditional cash and credit mechanisms. Customers interested in availing of such program can be directed, for example, to an internet site that provides further information, as well as online registration forms and tools.

As a consequence of enrollment, the customer is issued a unique primary account, used for containing or having associated therewith information uploaded or submitted by the customer and other data computed therefrom for system operation (cf., the “customer-defined group of payment instruments” and existing authentication account data). As to the latter, computed data is generated by retailer network assets from or as a result of inputted data received from the customer, such as occasioned by a customer selection of a payment instrument, as well as an authorized automatic addition and/or manual selection of an existing customer authentication account.

The primary customer account and data contained or associated therewith are recorded in the data storage facility 10 within the retailer network 100.

The data storage facility can comprise one or more data storage devices capable of recording and retrieving digital information from a medium (e.g., magnetic, optical, semiconductor, etc.). For small to medium-scale retailers, the data storage facilities can utilize storage with comparatively modest capacity, such as provided by a single internal or external hard drive or flash drive. For large global employers, the data storage facilities will require greater capacity and bandwidth, and thus, may employ several networked and attached electronic data storage components, these being deployed at an enterprise-scale and may include, for example, arrays of data servers and file servers; SAN and NAS storage facilities; RAID storage systems; data backup, archiving, and redundancy facilities; and data management and load balancing agents.

Once enrolled, customer can add payment instruments and existing customer accounts to the primary customer account.

As used herein, the term “payment instruments” is defined as any electronically available source of money or finance, such as bank accounts 40b, credit and debit accounts 40c, electronic wallets 40a, shopping and gift card programs 40d, and the like.

Inclusion into this program will likely involve—as shown in FIG. 1—accessing data from the responsible providers through the internet 5 via an API, and as such, may require pre-agreement and coordination between the retailer and the providers. Such business arrangements are customary in the retail industry and should not be a technical hindrance to the practice of this invention. Specific examples of preferred providers include “MasterCard”, “VISA”, “American Express”, “Discover”, “GreenDot”, “Sam's Club”, and “Google Wallet”.

As to the “existing customer accounts, these will likely comprise older accounts that were assigned by the retailer to the customer at an earlier time. Since these accounts are likely still recorded within the retailer's network (or accessible subsidiary segment thereof), identification of these existing “legacy” accounts would be comparatively straightforward, for example, by automatically sweeping network data for older accounts using a telephone number, address, email, or name that the customer had submitted at enrollment.

In respect of authentication though, it is not necessary that the existing account be one held by the customer with the retailer. Third party accounts can be used, provided parameters set by the retailer in respect to security and technical compatibility are met.

Examples of third party accounts that could be used as an authentication account includes accounts associated with the aforementioned payment instruments; social network accounts (e.g., “Facebook”); and retailer partner accounts (such as, frequent flyer accounts, organizational and club membership accounts, and preferred hotel customer accounts).

As is the case with the payment instruments, certain authentication accounts may require the sharing of electronic data from third parties networks, and accordingly, may require contractual coordination (i.e., between the retailer and the third party), appropriate pre-authorizations (i.e., by the customer, retailer, and/or third party), and the establishment of appropriate and/or compatible electronic data format and security policies (i.e., as per the third parties' APIs).

Once enrolled, with payment instruments selected, the customer is able to go to any of the participating shopping facilities operated by the retailer, possibly without cash or credit card, and purchase merchandise, simply by accessing his primary customer account at checkout.

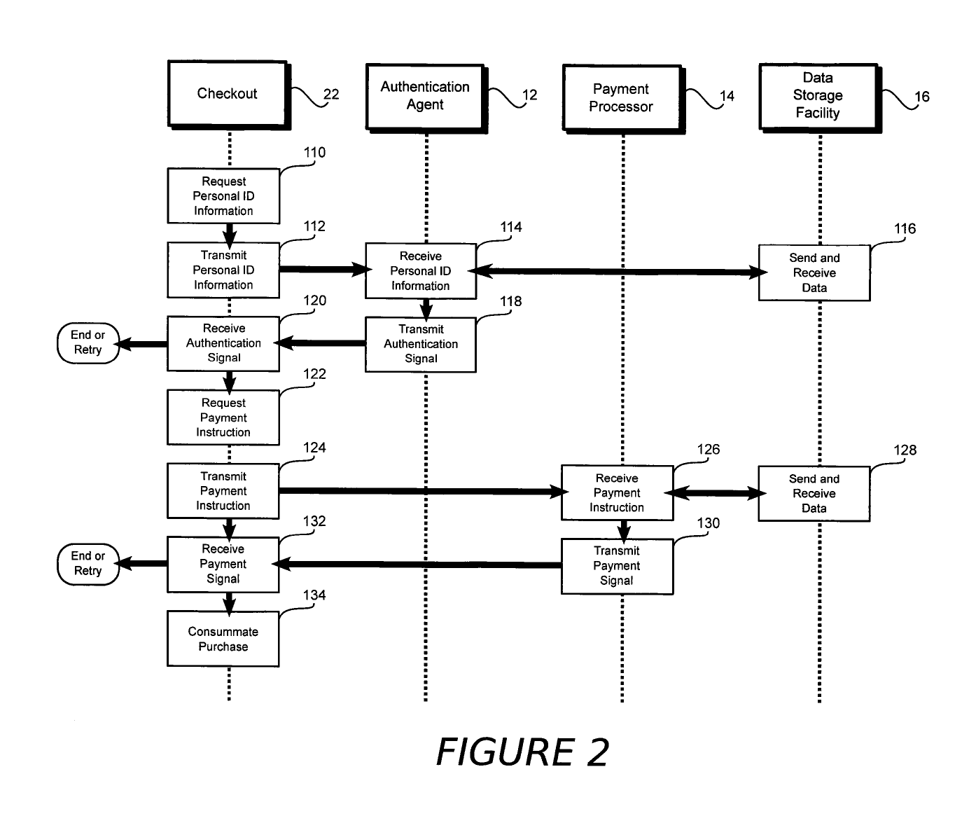

To explain this further, reference is now made to the cross-functional flowchart of FIG. 2. The functionalities therein are the “Checkout” facility 22; the “Authentication Agent” 12; the “Payment Processor” 14, and the “Data Storage Facility” 16.

After a customer has acquired merchandise from the shopping facility, he can then proceeds to checkout to consummate his purchase. At checkout 22, the customer at a payment terminal, for example, is presented with a request for personal ID information 110. Thusly prompted, the customer then inputs his response(s) to the request, which is then transmitted 112 by the checkout means 22 to the authentication agent 12.

For purposes of authentication, the advantages offered by the present invention are more fully realized where the retailer's authentication policy dictating the use of any particular “personal ID information” format is based on either so-called “knowledge factors” (e.g., passwords, personal identification numbers, challenge questions, etc.) and/or “inherency factors” (e.g., fingerprint, voiceprint, and other biometric identifiers). Authentication based on such factors can be accomplished on the spot by inputting “personal ID information” that a customer will always have present, regardless of time or circumstance. In contrast, authentication based on “ownership” of a personal item (e.g., a credit, bank, or ID card, a security token, an RFID tag or fob, or mobile phone) are not preferred to the extent that such non-personal account identifiers would reduce considerably the breadth of customer accessibility.

If the retailer's authentication policy utilizes “knowledge factors”, the format for the “personal identification information”—such as the data type, content, and means of input—will typically comprise alphanumeric data strings representative of a customer account (e.g., an account name, an account number, a telephone number, an email address, etc.) and a personal code (e.g., a password, a passcode, a PIN, or an answer to a challenge question). Such alphanumeric data can be inputted by the customer at checkout 22 through the use of a keyboard, keypad, or touch screen display. If the retailer's authentication policy utilizes “inherency” factors, checkout 22 will include a suitable reader, scanner, or other sensing device, such as a electronic signature pad (for signature acquisition), a microphone (for voice identification), and/or a camera (for facial recognition).

Upon receipt of the personal ID information at the authentication agent 12, authentication processes are executed therein involving the sharing 116 and comparing of the submitted data with pertinent customer identification related data registered at or otherwise accessible through the data storage facility 16.

Additional details of the operation, coding, implementation, and hardware requirements of several and various authentication processes is well known and well documented in the art. In respect of the patent literature, reference can be made, for example, to U.S. Pat. No. 8,255,971, issued to T. A. Webb et al. on Aug. 28, 2012; U.S. Pat. No. 8,302,172, issued to M. Grandcolas et al. on Oct. 30, 2012; U.S. Pat. No. 8,347,405, issued to R. A. Backhouse on Jan. 1, 2013; U.S. Pat. App. Pub. No. 2012/0260322, filed by A. P. D. Logan et al. on Apr. 8, 2011; U.S. Pat. App. Pub. No. 2012/0215688, filed by P. Musser et al. on Feb. 23, 2012; U.S. Pat. No. 7,765,580, issued to R. J. Vandergeest et al. on Jul. 27, 2010; and U.S. Pat. No. 5,764,789, issued to D. F. Pare, Jr. et al. on Jun. 9, 1998.

It will be appreciated that the operation of the authentication agent 12—as the case also with the payment processor 14—will adopt, implement, or otherwise conform to one or many of the well known security protocols used for protecting financial transactions. This includes the use of secure sockets, encryption, firewalls, public and private keys, digital certificates, and the like. Embodiments of the invention, where checkout 22 is limited exclusively to physical points-of-sale, can attain additional security, for example, by designing the authentication process to be a function also of the MAC addresses (or other embedded unique device codes) of the checkout devices authorized to implement the invention.

Processing of the “personal ID information” by the authentication agent 12 ultimately results in an “authentication signal” representative of whether the customer's inputted information conforms to the retailer's authentication policy. The authentication agent 12 transmits the authentication signal 118 to the checkout device. And, subsequent to the receipt thereof 120, the checkout 22 can either proceed (i.e., in the case of positive authentication) or, if authentication failed or was inconsistent with the retailer's authentication policy, retry or terminate the authentication session.

If authentication is successful, checkout means 22 then proceeds to prompt the customer for his payment instructions 122, which here is essentially the selection by the customer of the payment instrument through which the customer's merchandise will be purchased. Typically, the request 122 presents the customer with a menu of available payment instruments, with the payment instruction thus comprising the data generated by the customer in course of inputting his selection.

Once inputted, the payment instruction is transmitted from the checkout 22 to the payment processor 14. Upon receipt 126 at the payment processor 14, payment processes are executed therein, involving the exchange 128 of the submitted payment instruction data and pertinent customer payment related data registered at or otherwise accessible through the data storage facility 16. Payment processing can also involve other network components and assets (not shown in FIG. 2), such as risk management servers and modules, that are activated in the course of commencing and/or consummating an electronic financial transaction with a third-party financial partner. Some of the payment processing can also relate to the maintenance of accuracy and currency of the customer's financial accounts as recorded within a third-party's network (e.g., maintaining an accurate timely record of balances, credits, debits, and transfers in a customer's personal checking account).

For example, as shown in FIG. 1, in preferred embodiments of the invention, payment processing involve communication and data exchange through the internet 5 between the retailer-operated computer network 10 and the networks of the external third parties that underwrite, manage, service or otherwise provide the payments instruments 40. In this context, at least some of the “customer payment related data” registered at the data storage facility 16, as well as algorithms and processes executing at the payment processor, will relate to the encoding, data shaping, formatting, and routing necessary to access and utilize the third parties' available network resources and assets through their network APIs.

Additional details of the operation, coding, implementation, and hardware requirements of electronic payment processes are well known and well documented in the art. In respect of the patent literature, reference can be made, for example, to U.S. Pat. App. Pub. No. 2013/0080333, filed by O. Kamotskyy et al. on Sep. 27, 2011; U.S. Pat. App. Pub. No. 2012/0330788, filed by R. Hanson et al. on Jun. 27, 2011; U.S. Pat. App. Pub. No. 2003/0212632, filed by J. Keogh et al. on Jan. 7, 2003; U.S. Pat. App. Pub. No. 2011/0029416, filed by A. Greenspan on Dec. 7, 2009; U.S. Pat. App. Pub. No. 2012/0303532, filed by J. May on Aug. 8, 2012; and U.S. Pat. App. Pub. No. 2013/0080325, filed by D. Schatt et al. on Mar. 28, 2013.

Regardless of the specific payment processes implemented, in accordance with the invention, payment processing ultimately results in the transmission of a payment signal from the “payment processor 14 back to checkout 12. The payment signal—as a function of payment processing—will essentially represent or codify at the least an “acceptance” or “rejection” of the use of the selected payment instrument for purchase of the customer's merchandise. The payment signal can, of course, include other information, such as remaining balances, transaction times, charges, fees, error codes, and the like.

Subsequent to receipt 132 of the payment signal back at checkout 22, checkout 22 can either finalize the purchase (cf., “accepted” payment) 134 or, in the case of a payment rejection or the like, either terminate the session or retry it at earlier stage (e.g., requesting another payment instruction 122 whereby a different payment instrument can be selected). For rejections and the like, information can be carried on the payment signal, and extrapolated at checkout to explain the reason for the rejection, e.g., insufficient funds, overdraft, withdrawal limitations, etc.

As mentioned above, there are at least two principal means by which a customer can access, use, or otherwise interact with his customer account within the retailer's electronic payment program: i.e., either through the use of a personal computer 30 to access a retailer-operated internet site (for example, at the customer's home) or through the use of a suitably configured electronic payment system at checkout 22 (for example, at a participating retailer-operated shopping facility).

With regard to the former, the primary functions in the preferred embodiments of such internet site are (a) to enable customer subscription into the electronic payment program and (b) the editing and review of the resulting customer account.

Such internet site, published through web server 14, is accessed at a URL address, using an internet browser or other suitable web interface, through a personal computer device 30, such as a personal computer, tablet, or smartphone.

Programming for the internet site includes HTML, alone or in combination with other internet programming and scripting languages, preferably providing feature-rich functionality, such as dynamic data interchange, presentation, and management; cross browser/device compatibility, and appropriate online safeguards and security. Other programming and scripting languages include PHP, Javascript, JQuery, XML, Ajax, and Java. CSS can be used, for example, to provide good cross browser/device compatibility.

The computing resources for the internet site need not be contained in one logical or physical location of the retailer's computer network 10. The technical resources can be distributed. For example, the internet site can be published using a web application executing on web server 16, sharing data with data storage facility 16 and protected by security devices running on the network edge. For global retailers, the supporting resources and facilities can be massive. For smaller retailers, these resource can be more modest, potentially comprising—albeit extreme—a single personal computer with internet access.

The customer interface for the internet site is preferably provided with intuitive navigation tools; tabs, pointers, buttons, and other hyperlinks to site functions (e.g., subscription, editing, and review), external third-party partner sites, and other coexisting websites on the retailer's network (e.g., the retailer's homepage, ecommerce site, and subsidiary sites); searching, sorting, charting, and data filtering capabilities for reviewing account transactions, balances, and patterns; electronic forms and fields needed for or otherwise relevant to the activation, selection, and editing of the customer's payment instruments (including transfers therebetween); technical guidance and information related to retailer policies and procedures; and promotional and marketing collateral for the consolidated electronic payment program.

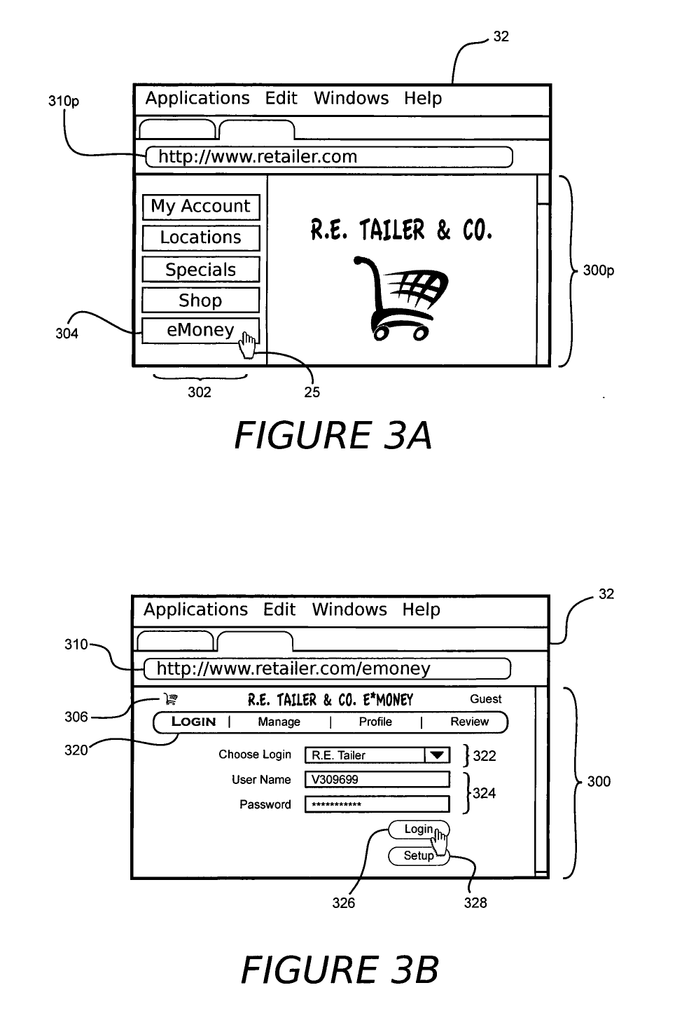

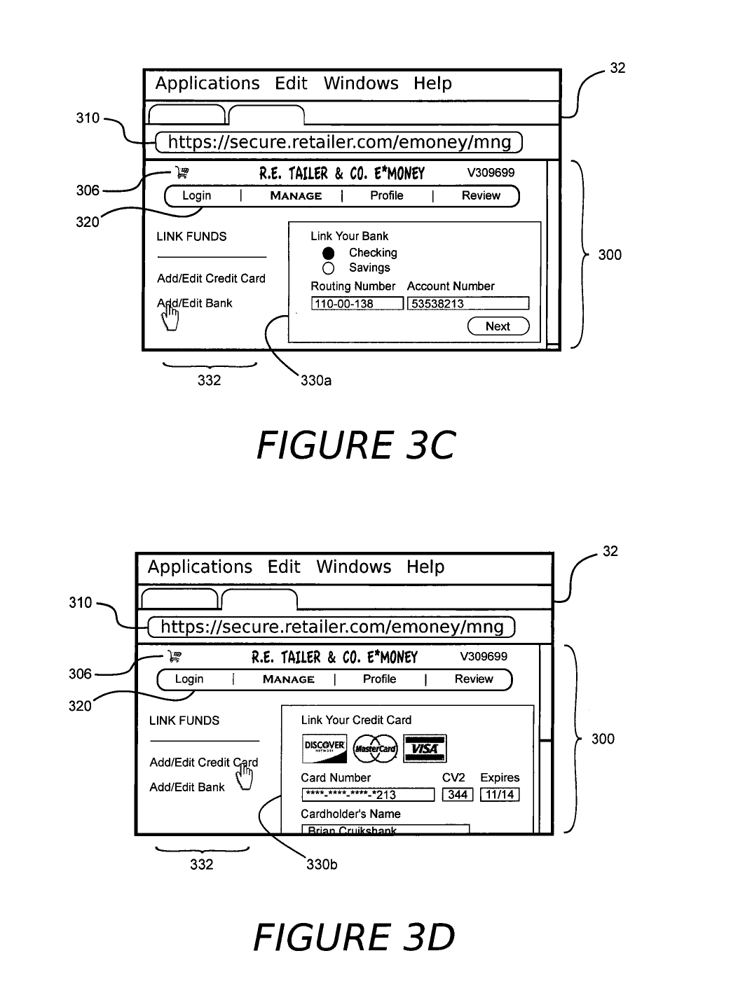

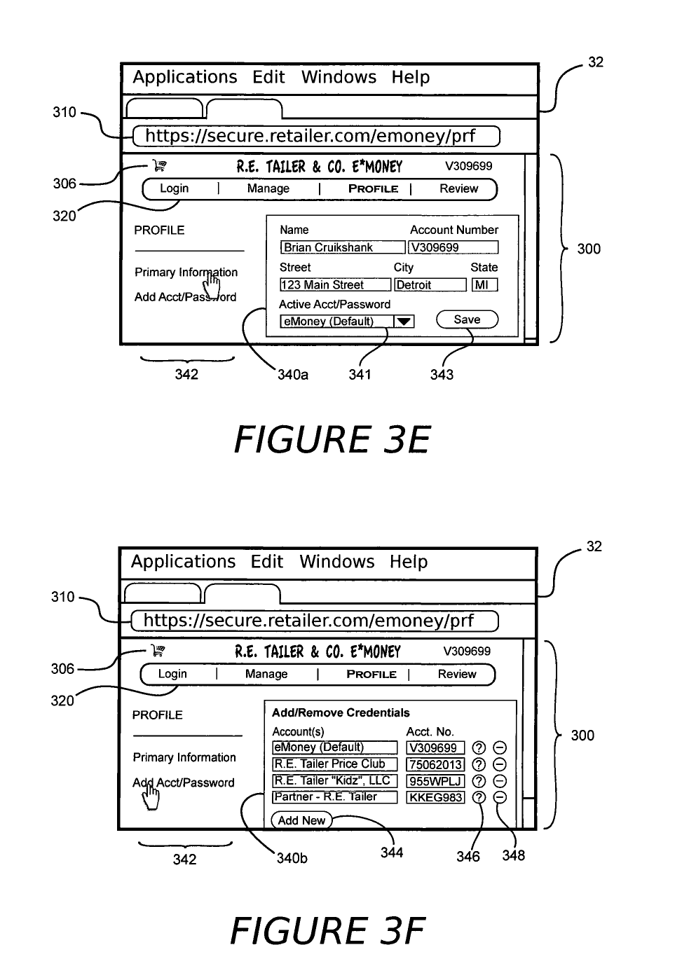

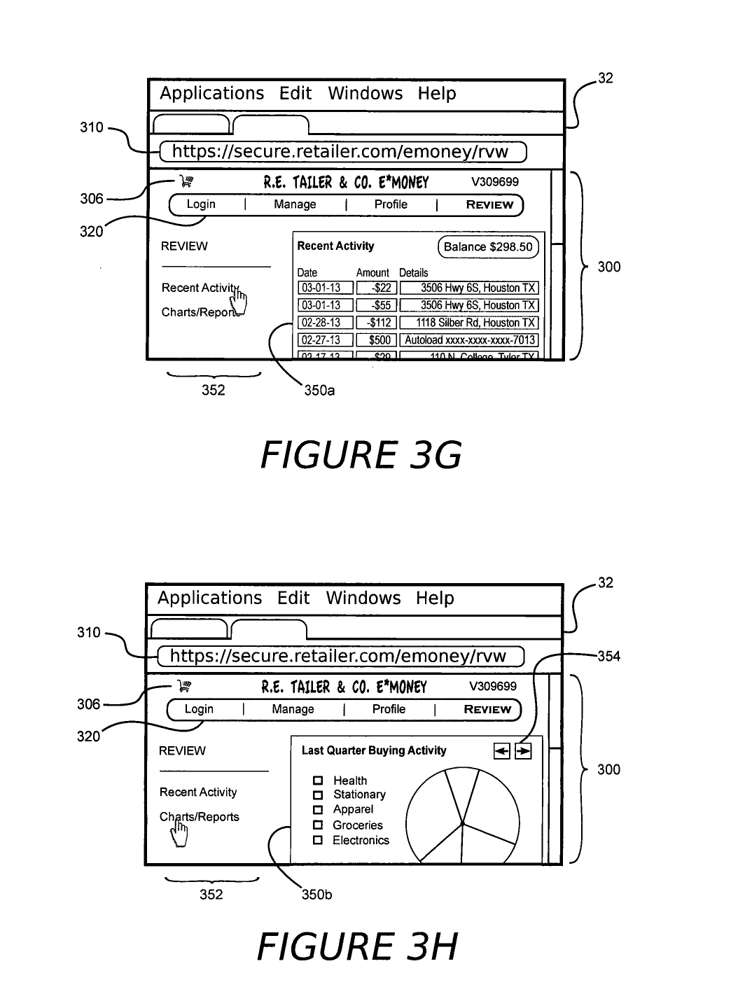

To further describe the invention, the configuration and operation of a representative internet site 300 is illustrated schematically in FIGS. 3A to 3H.

In particular, through the use of an internet browser (or app) 32 executing on a personal computer (or suitable smartphone), the customer accesses the inventive program's internet site 300 through the retailer's parent website 300a.

As shown in FIG. 3A, the retailer's parent website 300a (located URL address 310p) provides a menu 302 comprising a plurality of button activated hyperlinks pointing to a number of services, functions, information and other like content 308. Amongst the menu items 302 is a button-activated hyperlink to the inventive program 204, hypothetically entitled herein “eMoney”. Moving the browser's cursor 25 to the button and activating it leads into the invention's internet site 300.

The landing site for the invention's internet site 300—as shown in FIG. 3B—is a login page located at a specific URL address 310 (i.e., “secure.retailer.com/emoney”) under the retailer's top-level domain (i.e., “retailer.com”). Navigation back to the retailer's parent website can be accomplished using a suitable hyperlink, such as one anchored to clickable image 306.

The login page includes a navigation bar 320, with clickable hyperlinks to site 300's four principal sections entitled “Login”, “Manage”, “Profile”, and “Review”. The “Login” page further comprises fields for inputting the “personal ID information” 324 (i.e., a “User Name” and “Password”) required for further access into the customer's “eMoney” account. Also shown is a login selector 322, with a drop down menu, for selecting any available and compatible login forms that may have been associated with existing accounts that had been earlier incorporated in to the “eMoney” account. Upon completion of the “personal ID information” fields, login is accomplished by clicking “Login” button 324.

If the customer does not yet have an “eMoney” account, subscription is effected by clicking “Setup” button 328, which links to the electronic forms, agreements, and authorizations, required by the retailer to initiate a new account. As a result of opening a new account, the customer is issued a unique account number. For illustrative purposes, in FIG. 3B, the unique account number is also used in internet site 300 as the customer's “User Name” (i.e., “V309699”).

The means for editing, adding, and deleting the customer's set of available payment instruments on the “eMoney” internet site 300 are accessed by clicking on the “Manage” hyperlink in navigation bar 320.

Within this “Manage” section—as shown in FIGS. 3C and 3D—a clickable menu of services 332 is displayed, with each menu item leading to the content and forms 330a and 330b relevant to those services. In particular, in FIG. 3C, clicking on the service entitled “Add/Edit Bank”, leads to content 330a comprising radio button selectors (for selecting between types of bank accounts) and input fields (for entry of, for example, bank account numbers and routing numbers). Likewise, in FIG. 3D, clicking on the service entitled “Add/Edit Credit Card”, leads to content 330b comprising several fields for inputting the customer's credit card account information, such as a credit card number, a “CV2” verification code, an expiration date, a customer name, a customer address, etc.

In respect of both FIGS. 3C and 3D, although not illustrated, other content and functions relevant to registering, editing, and deleting payment instruments, including links to third-party financial networks, are known to those skilled in the art, and can be incorporated.

The means for editing the customer's account profile, including the addition and deletion of existing customer accounts, are accessed on the “eMoney” internet site 300 by clicking on the “Profile” hyperlink in navigation bar 320.

Within this “Profile” section—as shown in FIGS. 3E and 3F—a clickable menu of services 342 is displayed, with each menu item leading to the content and forms 340a and 340b relevant to those services. In particular, in FIG. 3E, clicking on the service entitled “Primary Information”, lead to content 340a, which comprises: Several fields for inputting or editing personal information, such as the customer's name and address; a drop down menu 341 through which the customer can select the “personal ID information” used for authentication at checkout; and a save button 343. Likewise in FIG. 3F, clicking on the service entitled “Add Acct/Password”, leads to content 340b, which comprises: A list of existing accounts that are federated into “eMoney account” for purposes of authentication, each being identified by name and account number; clickable information buttons 346, leading for example to detailed information about the existing account and/or editing tools; deletion buttons 348 that enable a customer to remove an “existing account” from the federation; and clickable button 344, that leads to additional forms and content relevant to adding new authentication accounts.

In regards to the federation of existing authentication accounts in FIG. 3F, there will in all embodiments of invention be at least one primary authentication account, i.e., the account created for the inventive system. The other existing accounts can either be added automatically at the initiation of a new primary customer account (cf., FIG. 3B, button 328) or added manually by the customer over time (cf., FIG. 3F, button 344). As to the former, automatic addition will typically entail the incorporation of any existing accounts that may already be held by the customer with the retailer (e.g., “legacy” and “subsidiary” accounts), the records and information therefore likely being already located within that retailer's own network. In contrast, consolidation into the primary account of existing third-party authentication accounts may require manual addition.

The means for reviewing account activity on the “eMoney” internet site 300 are accessed by clicking on the “Review” hyperlink in navigation bar 320.

Within the “Review” section—as shown in FIGS. 3F and 3H—a clickable menu of services 352 is displayed, each item leading to the content and forms 350a and 350b relevant to those services. In particular, in FIG. 3G, clicking on the item entitled “Recent Activity” leads to content 350a comprising: The current available balance of the “eMoney” account; and a list of recent transactions associated with that account, identified for example by date, amount, and the like. Similarly, clicking on the item entitled “Charts and Report”, leads to content 350b, comprising charts and reports generated from intrinsic (and/or extrinsic) data linked to or otherwise associated with the “eMoney” account, as well as any relevant editing, formatting and navigation tools 354.

In preferred embodiments, customer checkout is performed at a physical checkout station, located within a traditional retailer-operated “bricks-and-mortar”shopping facility, utilizing a customer payment terminal.

In respect of technical configurations, the customer payment terminal can either be combined, incorporated, or otherwise implemented within an unattended “self-service” checkout station or within a more traditional cashier-attended checkout station. Such point-of-sale systems and frameworks, including components and accessories therefor, are available commercially from, for example, Casio Corporation (Tokyo, Japan), Sharp Corporation (Osaka, Japan), NCR Corporation (Duluth, Ga.), Toshiba TEC Corporation/IBM (Tokyo, Japan), and Hewlett-Packard Company (Palo Alto, Calif.). Many of these commercially-available point-of-sale systems include customer-facing payment terminals having software or operating systems that can be customized or modified, inherently or otherwise, by those skilled in the art, to incorporate the functionality of the invention's “customer payment terminal”.

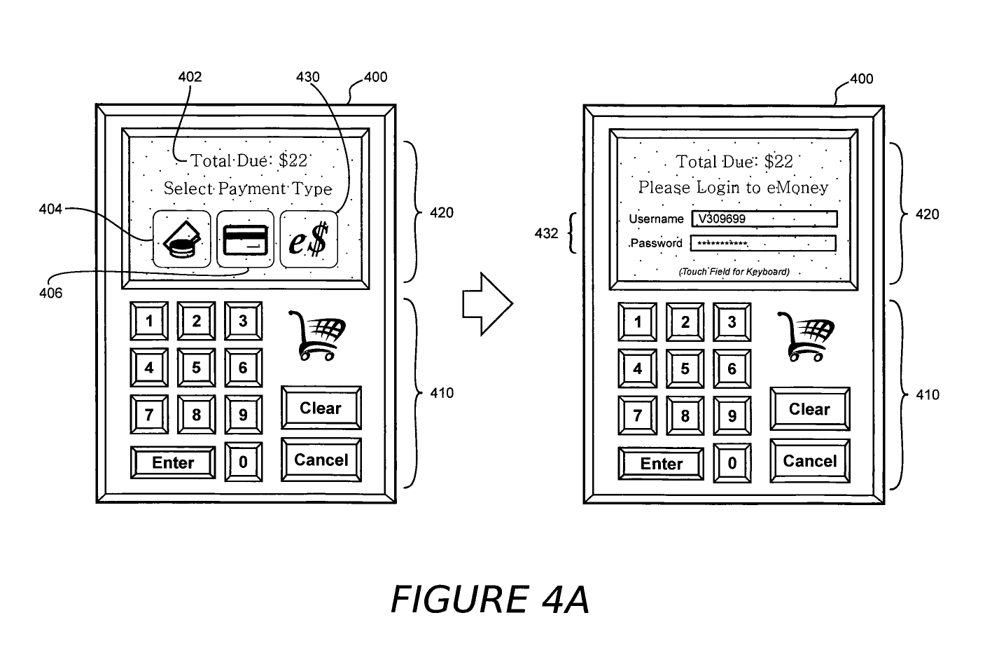

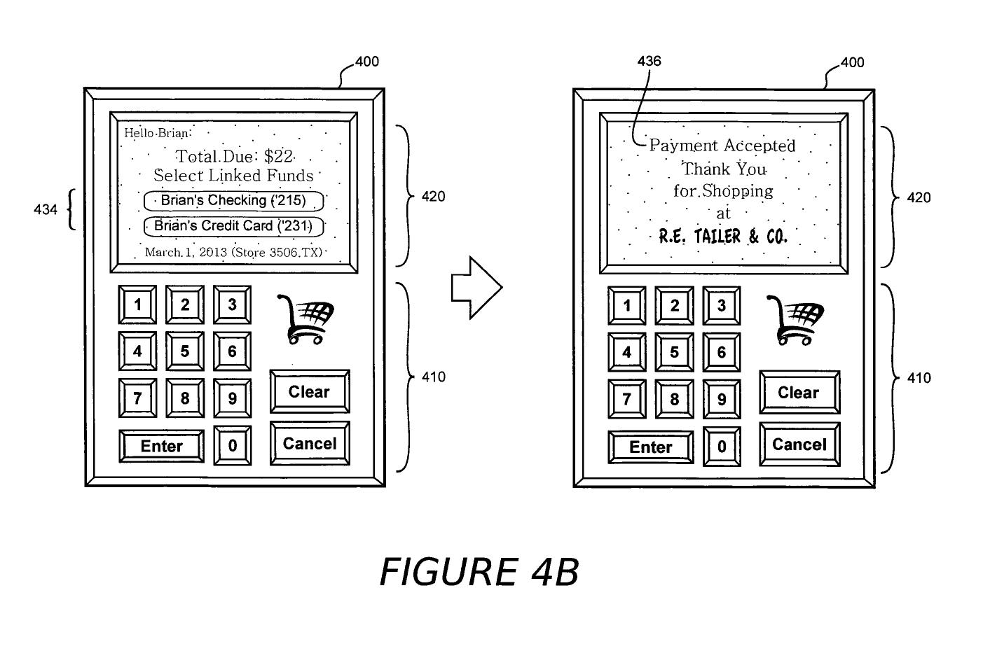

FIGS. 4A to 4B collectively provide a representative example of the operation of a customer payment terminal at checkout 22, the terminal illustrated therein comprising a panel 400 with a number pad 410 and a touch-sensitive flat panel display 420.

After scanning, registering, or otherwise identifying each item of merchandise brought to checkout, the customer is notified at the payment terminal of the total purchase price for his items and presented with a number of payment options, including a traditional cash payment option 404, a traditional credit card option 406, and the inventive “eMoney” option 430.

As shown in FIG. 4A, subsequent to his selection of the “eMoney” option 430, the customer is presented on display 420 with a login screen gating access into his account. The customer is requested or otherwise prompted to enter the “personal ID information” (e.g., a username and password) established by the customer for authenticating his access. The information entered into the login screen is transmitted to the system's authentication agent 12, which ultimately transmits back an authentication signal based on a computational review of the submission.

Subsequent to successful authentication, the customer is presented—as shown in FIG. 4B—with a number of payment options 434, each corresponding to a payment instrument 40 that the customer has or had linked to his primary “eMoney” account. Upon selecting one of the payment options 434, a payment instruction is transmitted to the system's payment processor 14, which ultimately transmits back a payment signal based on the computational payment processes executed at the payment processor and/or relevant third-party payment partner. If the payment signal encodes an “acceptance”, the purchase of the customer's items is consummated, and an acknowledgement 436 thereof presented to the customer on the terminal's display 420.

Although several embodiments of the invention are disclosed hereinabove, those skilled in the art having the benefits of this disclosure can effect modifications thereto. These modifications are to be construed as being encompassed within the scope of the present invention as set forth in the appended claims.

1. A cardless retailer-operated electronic payment system that enables a customer to purchase merchandise at a retailer-operated store, the payment system comprising:
(a) a retailer-operated computer network that includes
(i) a data storage facility storing a primary customer account assigned by said retailer to said customer, the primary customer account having associated therewith a customer-defined group of payment instruments,
(ii) an authentication agent capable of authenticating personal identification information and subsequently transmitting a customer authentication signal composed as function of said authentication,
(iii) a payment processor capable of processing a payment instruction and subsequently transmitting a payment signal composed as a function of said processing, the payment instruction including a selection of at least one of said group of payment instruments,
(iv) a web server providing a customer interface for creating, accessing, and editing the primary customer account;
(b) a checkout station located at said retailer-operated store and including a customer payment terminal, the customer payment terminal
(i) capable of receiving personal identification information from said customer, transmitting the personal identification information to the authentication agent, and receiving the customer authentication signal from the authentication agent in response to said transmission, and
(ii) capable of requesting the payment instruction from said customer as a function of the authentication signal, and after said request, receiving the payment instruction from said customer, transmitting the payment instruction to the payment processor, and receiving the payment signal from the payment processor in response to said transmission.

2. The cardless retailer-operated electronic payment system of claim 1, wherein the personal identification information consists essentially of an account name and a passcode.

3. The cardless retailer-operated electronic payment system of claim 2, wherein the account name is an email address.

4. The cardless retailer-operated electronic payment system of claim 2, wherein the account name is a phone number.

5. The cardless retailer-operated electronic payment system of claim 1, wherein the personal identification information includes biometric information.

6. The cardless retailer-operated electronic payment system of claim 1, wherein said customer interface is an internet site providing services for said creating, accessing, and editing of said primary customer account, the internet site being accessible from within a parent website operated by the retailer.

7. The cardless retailer-operated electronic payment system of claim 1, wherein the payment instruments comprise a plurality of bank accounts and credit card accounts.

8. The cardless retailer-operated electronic payment system of claim 1, wherein the checkout station is a cashier-assisted checkout station.

9. A method enabling the purchase by a customer of merchandise at a retailer-operated store without the use of cash or a bank card, the method comprising the steps of:
providing a retailer-operated computer network hosting a customer account have associated therewith a customer-defined group of payment instruments, and capable of authenticating said customer as a function of personal identification information and authorizing payment from at least one of said group of payment instruments as a function of a customer instruction;
providing a checkout station located at said retailer-operated store that includes a customer payment terminal that is in communication with said retailer-operated computer network;
authenticating said customer at checkout by prompting said customer at said checkout station to input personal identification information at the customer payment terminal and transmitting the personal identification information to the retailer-operated network; and
authorizing payment for said merchandise at checkout by prompting said authenticated customer at said checkout station to input the customer instruction at the customer payment terminal and transmitting the customer instruction to the retailer-operated network, the payment instruction including a selection of at least one of said payment instruments.

10. The method of claim 9, wherein the personal identification information consists essentially of an account name and a passcode.

11. The method of claim 10, wherein the account name is an email address.

12. The method of claim 10, wherein the account name is a phone number.

13. The method of claim 9, wherein the personal identification information includes biometric information.

14. A retailer-operated electronic payment system that enables a customer to purchase merchandise at a retailer-operated shopping facility, the payment system comprising:
(a) a retailer-operated computer network that includes
(i) a data storage facility storing a primary customer account assigned by said retailer to said customer, the primary customer account having associated therewith a customer-defined group of payment instruments and one or more existing customer accounts, each existing customer account having a unique account identifier,
(ii) an authentication agent capable of transmitting a customer authentication signal as a function of receiving and authenticating the account identifier of at least one of said existing customer accounts, and
(iii) a payment processor capable of processing a payment instruction and subsequently transmitting a payment signal composed as a function of said processing, the payment instruction including a selection of at least one of said group of payment instruments; and
(b) checkout means provided in said retailer-operated shopping facility for
(i) receiving an account identifier from said customer, transmitting the account identifier to the authentication agent, and receiving the customer authentication signal from the authentication agent in response to said transmission, and
(ii) requesting the payment instruction from said customer as a function of the authentication signal, and after said request, receiving the payment instruction from said customer, transmitting the payment instruction to the payment processor, and receiving the payment signal from the payment processor in response to said transmission.

15. The retailer-operated electronic payment system of claim 14, wherein each of said existing customer accounts is an existing retailer-assigned customer account.

16. The retailer-operated electronic payment system of claim 15, wherein the unique account identifier of each existing retailer-assigned customer account is a personal account identifier consisting essentially of an account name and a passcode.

17. The retailer-operated electronic payment system of claim 14, wherein the retailer-operated computer network further includes:
(iv) a web server providing a customer interface for creating, accessing, and editing the primary customer account, including
(A) defining the group of payment instruments and
(B) adding and removing said existing customer accounts.
